(19) United States
(12) Patent Application Publication
(10) Pub. No.: US 2009/0067808 A1
(43) Pub. Date: Mar. 12, 2009

(54) Recording Apparatus and Method, and Recording Medium

(76) Inventors: Toshihiko FUSHIMI, Tokyo (JP); Kei HISANO, Tokyo (JP); Chieko KUSAKABE, Chiba (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/206,153

(22) Filed: Sep. 8, 2008

(30) Foreign Application Priority Data
Sep. 11, 2007 (JP) P2007-235005

(51) Int. Cl. G11B 27/00

(52) U.S. Cl. 386/54

(57) ABSTRACT

A recording apparatus dubs content recorded in a recording medium loaded into a different apparatus connected to the recording apparatus. The apparatus includes a database storing information in which the medium and identifiers are associated with each other, the identifiers specifying already dubbed scenes among scenes that are unit data items, a media-type determining unit that determines whether the medium in the different apparatus is a predetermined type of recording medium in which the content can be recorded in a form in which a unique identifier is added to each of the scenes forming the content, and a dubbing range setting unit that sets a dubbing range by using, as a new scene to be dubbed, a scene different from the already dubbed scenes on the basis of the information when it is determined that the medium in the different apparatus is the predetermined type of recording medium.

### CROSS REFERENCES TO RELATED APPLICATIONS

The present invention contains subject matter related to Japanese Patent Application JP 2007-235005 filed in the Japanese Patent Office on Sep. 11, 2007, the entire contents of which are incorporated herein by reference.

### BACKGROUND OF THE INVENTION

1. Field of the Invention

The present invention relates to recording apparatuses and methods, and recording media, and in particular, to a recording apparatus and method that simplify dubbing processing and provide a user-friendly content management system, and a recording medium used therewith.

2. Description of the Related Art

In recent years, audio visual devices having mass storage recording media, such as hard disk drive (HDD) recorders, have been in widespread use. In addition, devices that acquire digital data content by capturing images, such as camcorders and digital cameras, have been in widespread use. For example, content of an image captured by a camcorder or digital camera can also be dubbed to an HDD recorder.

In the case of dubbing content acquired by a camcorder or digital camera to an HDD recorder, measures are taken for each device so that a problem of dubbing already dubbed content again is avoided.

For example, an image data recording method (see, for example, Japanese Unexamined Patent Application Publication No. 2007-194861) has been proposed. In this method, a file name of an already recorded image file and a file name of an image file to be recorded are compared. If there are image files having the same file name, their shooting dates and times or pieces of exposure-related information at the time of shooting are further compared. If their shooting dates and times or pieces of exposure-related information at the time of shooting are not the same, a new file name is generated for the newer image file, the old file name is replaced by the new file name, and the new file name is recorded so that the original image is prevented from being overwritten, whereby, even if there are image files having the same file name, overwriting is prevented.

### SUMMARY OF THE INVENTION

A shorter dubbing time is better. In addition, it is preferable that a load on a device during dubbing be reduced.

Accordingly, to provide a convenient product, it is important to simplify processing in execution of dubbing.

In addition, to provide a convenient product, it is important to employ a user-friendly management method, such as arranging pieces of content in units of dates.

The present invention has been made in view of the foregoing circumstances, and it is desirable to provide simplification of dubbing processing and a user-friendly content management system.

According to an embodiment of the present invention, there is provided a recording apparatus for dubbing moving image content recorded in a recording medium loaded into a different apparatus connected to the recording apparatus, the recording apparatus including: a database configured to store information in which the recording medium and identifiers are associated with each other, the identifiers specifying already dubbed scenes among scenes that are unit data items forming the content recorded in the recording medium; media-type determining means for determining whether or not the recording medium in the different apparatus is a predetermined type of recording medium in which the content can be recorded in a form in which a unique identifier is added to each of the scenes forming the content; and dubbing range setting means for setting a dubbing range by using, as a new scene to be dubbed, a scene different from the already dubbed scenes on the basis of the information stored in the database when the media-type determining means determines that the recording medium in the different apparatus is the predetermined type of recording medium.

On the basis of the information stored in the database, the dubbing range setting means may specify the first scene to be newly dubbed among temporally consecutive scenes forming the content, and, on the basis of a free capacity of a recording medium in the recording apparatus, which contains the dubbed content, the dubbing range setting means may set the dubbing range by specifying the last scene to be newly dubbed among the temporally consecutive scenes forming the content.

When the media-type determining unit determines that the recoding medium in the different apparatus is not the predetermined type of recording medium, the dubbing range setting means may specify, as the first scene to be newly dubbed, the temporally oldest scene recorded in the recording medium in the different apparatus.

The recording apparatus may further include recording executing means for generating titles that are data items of recording units on the basis of shooting dates of the scenes, and recording the titles in the recording medium in the recording apparatus.

According to another embodiment of the present invention, there is provided a recording method for a recording apparatus that dubs moving image content recorded in a recording medium loaded into a different apparatus connected to the recording apparatus, the recording method including the steps of: determining whether or not the recording medium in the different apparatus is a predetermined type of recording medium in which the content can be recorded in a form in which a unique identifier is added to each of scenes forming the content; and when it is determined that the recording medium in the different apparatus is the predetermined type of recording medium, on the basis of information in which the recording medium and identifiers are associated with each other, the identifiers specifying already dubbed scenes among scenes that are unit data items forming the content recorded in the recording medium, the information being stored in a database, setting a dubbing range by using, as a new scene to be dubbed, a scene different from the already dubbed scenes.

According to another embodiment of the present invention, there is provided a program for causing a computer to function as a recording apparatus that dubs moving image content recorded in a recording medium loaded into a different apparatus connected to the recording apparatus, the recording apparatus including: a database configured to store information in which the recording medium and identifiers are associated with each other, the identifiers specifying already dubbed scenes among scenes that are unit data items forming the content recorded in the recording medium; media-type determining means for determining whether or not the recording medium in the different apparatus is a predetermined type of recording medium in which the content can be recorded in a form in which a unique identifier is added to each of the scenes forming the content; and dubbing range setting means for setting a dubbing range by using, as a new scene to be dubbed, a scene different from the already dubbed scenes on the basis of the information stored in the database when the media-type determining means determines that the recording medium in the different apparatus is the predetermined type of recording medium.

In the embodiments of the present invention, it is determined whether or not the recording medium in the different apparatus is a predetermined type of recording medium in which the content can be recorded in a form in which a unique identifier is added to each of the scenes forming the content. When it is determined that the recording medium in the different apparatus is the predetermined type of recording medium, a dubbing range is set by using, as a new scene to be dubbed, a scene different from the already dubbed scenes on the basis of the information stored in the database.

According to another embodiment of the present invention, there is provided a recording medium to be loaded into a different apparatus connected to a recording apparatus including: a database configured to store information in which the recording medium in the different apparatus and identifiers are associated with each other, the identifiers specifying already dubbed scenes among scenes that are unit data items forming the content recorded in the recording medium; media-type determining means for determining whether or not the recording medium in the different apparatus is a predetermined type of recording medium in which the content can be recorded in a form in which a unique identifier is added to each of the scenes forming the content; and dubbing range setting means for setting a dubbing range by using, as a new scene to be dubbed, a scene different from the already dubbed scenes on the basis of the information stored in the database when the media-type determining means determines that the recording medium in the different apparatus is the predetermined type of recording medium, wherein the content is recorded in a form in which a unique identifier is added to each of the scenes forming the content.

In the embodiment of the present invention, the content is recorded in a form in which a unique identifier is added to each of scenes forming the content.

According to another embodiment of the present invention, there is provided a recording apparatus for dubbing data recorded in a recording medium, the recording apparatus including: a database configured to store information in which the recording medium and identifiers are associated with each other, the identifiers specifying already dubbed unit data items among unit data items recorded in the recording medium; media-type determining means for determining whether or not the recording medium is a predetermined type of recording medium in which the data items can be recorded in a form in which a unique identifier is added to each of the unit data items; and dubbing range setting means for setting a dubbing range by using, as a new unit data item to be dubbed, a unit data item different from the already dubbed unit data items on the basis of the information stored in the database when the media-type determining apparatus determines that the recording medium is the predetermined type of recording medium.

According to another embodiment of the present invention, there is provided a recording method for a recording apparatus that dubs data items recorded in a recording medium, the recording method including the steps of: determining whether or not the recording medium is a predetermined type of recording medium in which the data items can be recorded in a form in which a unique identifier is added to each of unit data items; and when it is determined that the recording medium is the predetermined type of recording medium, on the basis of information in which the recording medium and identifiers are associated with each other, the identifiers specifying already dubbed unit data items among the unit data items recorded in the recording medium, the information being stored in a database, setting a dubbing range by using, as a new unit data item to be dubbed, a unit data item different from the already dubbed unit data items.

In the embodiment of the present invention, it is determined whether or not the recording medium in the different apparatus is a predetermined type of recording medium in which the data items can be recorded in a form in which a unique identifier is added to each of unit data items. When it is determined that the recording medium is the predetermined type of recording medium, on the basis of information in which the recording medium and identifiers are associated with each other, the identifiers specifying already dubbed unit data items among the unit data items recorded in the recording medium, the information being stored in a database, a dubbing range is set by using, as a new unit data item to be dubbed, a unit data item different from the already dubbed unit data items.

According to the present invention, dubbing processing can be simplified and a user-friendly content management method can be provided.

### BRIEF DESCRIPTION OF THE DRAWINGS

FIG. 1 is a block diagram showing an example of the configuration of a recording apparatus according to an embodiment of the present invention;

FIG. 2 is an illustration showing an example of the configuration of content recorded in a medium in a camcorder;

FIG. 3 is an illustration showing an example of the configuration of content captured in the recording apparatus;

FIG. 4 is a block diagram illustrating information stored in the recording apparatus.

FIG. 5 is a block diagram showing a functional configuration example of a control unit in the recording apparatus;

FIG. 6 is a flowchart illustrating a data capturing process;

FIG. 7 is an illustration showing an example of a screen displayed in connection with the process shown in FIG. 6;

FIG. 8 is an illustration showing another example of the screen displayed in connection with the process shown in FIG. 6;

FIG. 9 is a flowchart illustrating a capturing executing process;

FIG. 10 is an illustration showing an example of a screen displayed prior to the process shown in FIG. 9;

FIG. 11 is an illustration showing an example of the bar chart on the screen shown in FIG. 10;

FIG. 12 is an illustration showing an example of a screen displayed while the process shown in FIG. 9 is being executed; and

FIG. 13 is a block diagram showing an example of the configuration of a personal computer.

### DESCRIPTION OF THE PREFERRED EMBODIMENTS

Before describing an embodiment of the present invention, the correspondence between the features of the claims and the specific elements disclosed in an embodiment of the present invention is discussed below. This description is intended to assure that an embodiment supporting the claimed invention are described in this specification. Thus, even if an element in the following embodiment is not described as relating to a certain feature of the present invention, that does not necessarily mean that the element does not relate to that feature of the claims. Conversely, even if an element is described herein as relating to a certain feature of the claims, that does not necessarily mean that the element does not relate to other features of the claims.

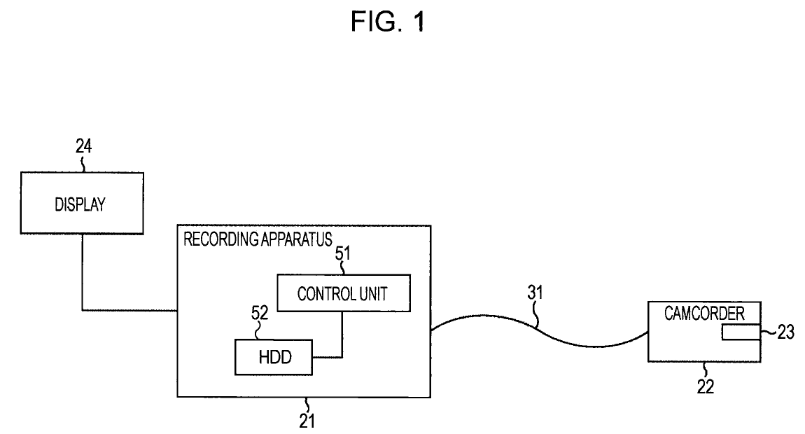

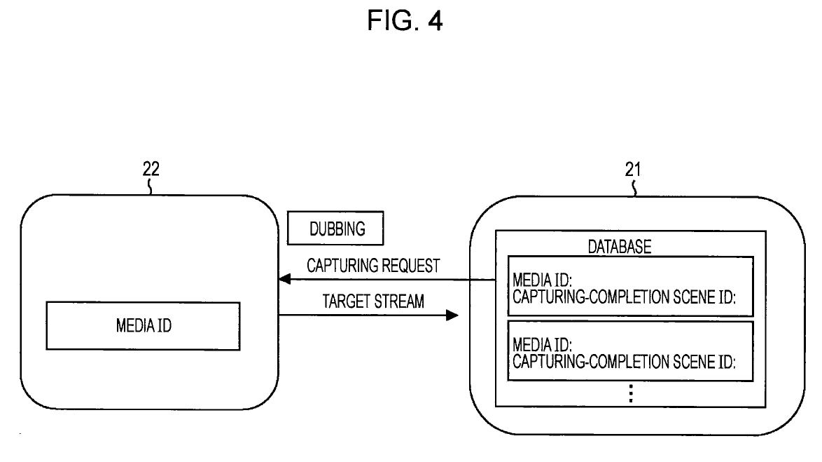

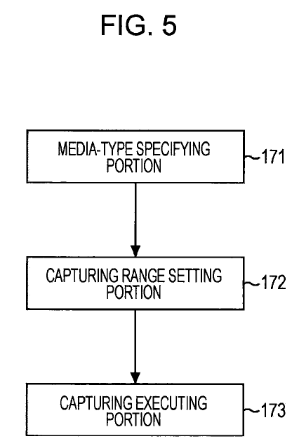

An embodiment of the present invention provides a recording apparatus for dubbing moving image content recorded in a recording medium (e.g., the medium 23) loaded into a different apparatus (e.g., the camcorder 22 shown in FIG. 1) connected to the recording apparatus, the recording apparatus including: a database (e.g., the database shown in FIG. 4) configured to store information in which the recording medium and identifiers are associated with each other, the identifiers specifying already dubbed scenes among scenes that are unit data items forming the content recorded in the recording medium; media-type determining means (e.g., the media-type specifying portion 171 shown in FIG. 5) for determining whether or not the recording medium in the different apparatus is a predetermined type of recording medium in which the content can be recorded in a form in which a unique identifier is added to each of the scenes forming the content; and dubbing range setting means (e.g., a capturing range setting portion 172) for setting a dubbing range by using, as a new scene to be dubbed, a scene different from the already dubbed scenes on the basis of the information stored in the database when the media-type determining means determines that the recording medium in the different apparatus is the predetermined type of recording medium.

On the basis of the information stored in the database, the dubbing range setting means may specify the first scene (e.g., a capturing-start scene) to be newly dubbed among temporally consecutive scenes forming the content, and, on the basis of a free capacity of a recording medium (e.g., the HDD 52 shown in FIG. 1) in the recording apparatus, the dubbing range setting means sets the dubbing range by specifying the last scene (e.g., a capturing-end scene) to be newly dubbed among the temporally consecutive scenes forming the content.

The recording apparatus may further include recording executing means (e.g., the capturing execution portion 173 shown in FIG. 5) for generating titles that are data items of recording units on the basis of shooting dates of the scenes, and recording the titles in the recording medium in the recording apparatus.

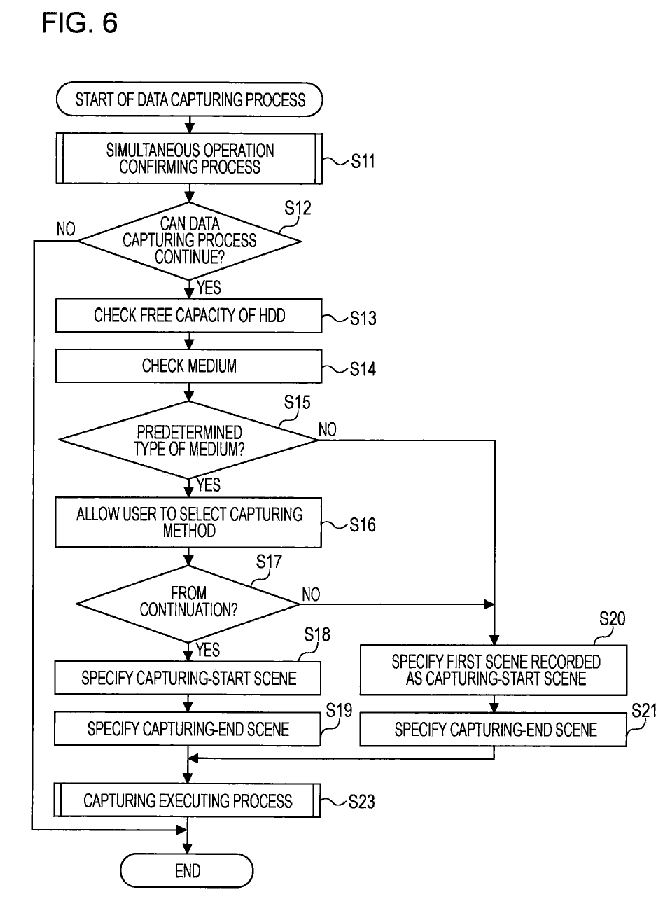

Another embodiment of the present invention provides a recording method for a recording apparatus that dubs moving image content recorded in a recording medium (e.g., a medium 23) loaded into a different apparatus (e.g., the camcorder 22 shown in FIG. 1) connected to the recording apparatus, the recording method including the steps of: determining (e.g., step S15 in FIG. 6) whether or not the recording medium in the different apparatus is a predetermined type of recording medium in which the content can be recorded in a form in which a unique identifier is added to each of scenes forming the content; and when it is determined that the recording medium in the different apparatus is the predetermined type of recording medium, on the basis of information in which the recording medium and identifiers are associated with each other, the identifiers specifying already dubbed scenes among scenes that are unit data items forming the content recorded in the recording medium, the information being stored in a database (the database shown in FIG. 4), setting (e.g., steps S18 and S19 in FIG. 6) a dubbing range by using, as a new scene to be dubbed, a scene different from the already dubbed scenes.

An embodiment of the present invention will be described below with reference to the accompanying drawings.

FIG. 1 shows an example of a recording apparatus 21 according to an embodiment of the present invention.

In FIG. 1, the recording apparatus 21 and a camcorder 22 have, for example, Universal Serial Bus (USB) interfaces, and both are connected to each other by a USB cable 31.

The recording apparatus 21 is formed by, for example, a hard disk drive (HDD) recorder. The recording apparatus 21 at least includes a control unit 51 for controlling execution of various types of processing, and an HDD 52 in which data such as content is recorded.

For example, a display 24 formed by, for example, a television receiver, is connected to the recording apparatus 21. For example, an image obtained by playing back content recorded in the HDD 52 is displayed on the display 24. In addition, an image, such as a graphical user interface (GUI) for use in operating the recording apparatus 21, is displayed on the display 24.

The camcorder 22 can take a moving image or still image, and can record the image as digital data content in a medium 23. The medium 23 is formed by, for example, a removable medium such as a Memory Stick.

The camcorder 22 generates data of moving image content in, for example, an Advanced Video Coding HD (AVCHD) format, and records the data in the medium 23.

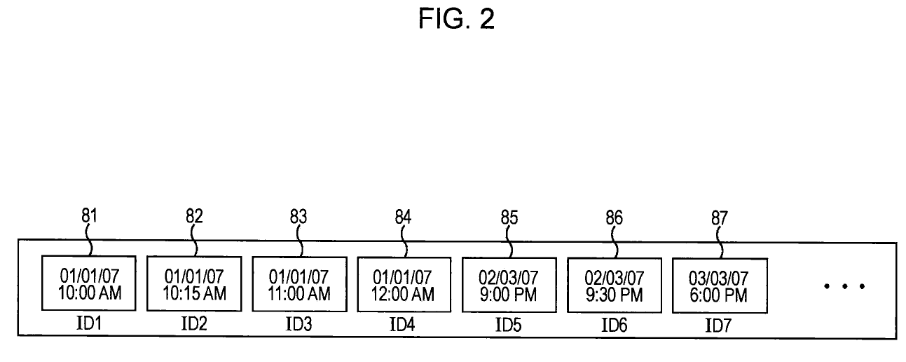

FIG. 2 shows an example of content recorded in the medium 23 after being taken by the camcorder 22.

As shown in FIG. 2, the content recorded in the medium 23 include a plurality of scenes such as scene 81, scene 82, scene 83, . . . , scene 87, . . . Here, a scene is a shooting unit of the camcorder 22. For example, a scene is temporally consecutive moving image data after the start of shooting is commanded until the end of the shooting is commanded.

For example, in FIG. 2, the scene 81 has the information “01/01/07 10:00 AM”. This indicates that the scene 81 is a moving image scene in which shooting was started on 10:00 AM, Jan. 1, 2007. Meanwhile, FIG. 2 does not indicate that the above information is not actually displayed on content or the like recorded in the medium 23.

In actually recorded data, a shooting start time of a scene is written in, for example, a field representing a recording date which is defined in the AVCHD format.

As described above, data of scenes recorded in the medium 23 includes data of a moving image and data of management information representing a shooting start time of the moving image.

In addition, in FIG. 2, IDs are added to scenes. In other words, “ID1” is added to scene 81, “ID2” is added to scene 82, . . . , “ID7” is added to scene 87. In this manner, the camcorder 22 adds an ID to data of each scene, and records the data in the medium 23.

An ID actually added to each scene is made up of, for example, a predetermined number (digits) of numerals or characters, and is unique to the scene. For example, if a new scene is shot and generated after scene 81 is deleted, “ID1” is not added to the scene. An ID added to each scene is hereinafter referred to as a “scene ID”.

Scenes constituting the content recorded in the medium 23 are recorded in order from the oldest shooting date and time. Also IDs to be added to the scenes are added in order so that their shooting time and date increase as the scenes are newer.

The recording apparatus 21 can perform dubbing of content recorded in the medium 23 in the camcorder 22 connected to the recording apparatus 21 via the USB cable 31. For example, on the basis of a user's command, a control unit 51 of the recording apparatus 21 can execute capturing of data of the content from the camcorder 22 and can record the data in the HDD 52.

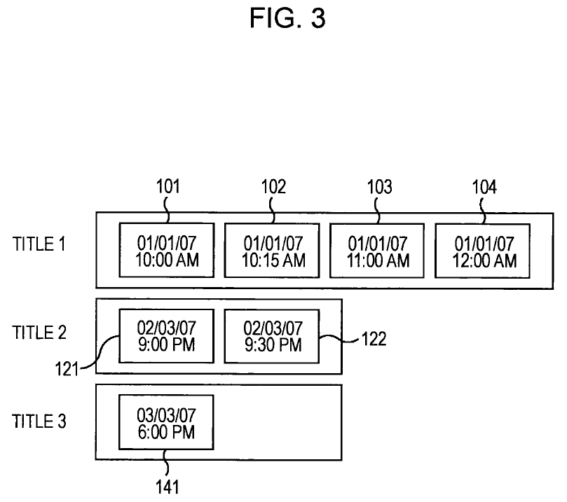

FIG. 3 shows an example in which content recorded in the medium 23 after being shot by the camcorder 22 is dubbed and recorded in the HDD 52 of the recording apparatus 21.

As shown in FIG. 3, the content recorded in the HDD 52 of the recording apparatus 21 is managed in units of titles. In this example, three titles, titles 1 to 3, are generated. In the recording apparatus 21, among the scenes recorded in the medium 23, scenes whose shooting was started on the same day are captured as a title.

In other words, among the three titles shown in FIG. 3, title 1 includes chapters 101 to 104. Chapter 101 is data of a moving image whose shooting was started on 10:00 AM, Jan. 1, 2007 (01/01/07 10:00 AM), and corresponds to scene 81. Similarly, chapters 102 to 104 are made up of moving images corresponding to scenes 82 to 84. The shooting dates of the moving images are each Jan. 1, 2007.

Title 2 includes chapters 121 and 122. Chapter 121 is data of a moving image whose shooting was started on 9:00 PM, Feb. 3, 2007 “02/03/07 9:00 PM”, and corresponds to scene 85. Similarly, chapter 122 is made up of a moving image corresponding to scene 86, and the shooting date of the moving image was also Feb. 3, 2007.

Title 3 includes chapter 141. Chapter 141 is data of a moving image whose shooting was started at 6:00 PM, Mar. 3, 2007 “03/03/07 6:00 PM”, and corresponds to scene 87.

As described above, the recording apparatus 21 generates a title for each shooting date, and records content in the HDD 52. For example, in cases such as when the content recorded in the HDD 52 is played back, by playing back the content for each shooting date, a user can easily understand the status, and it is convenient for the user to search for desired content.

Meanwhile, the recording apparatus 21 can store to what extent a scene acquired from the medium 23 was dubbed.

In a case where, after the camcorder 22 shoots and records scenes 81 to 84 in the medium 23, the camcorder 22 and the recording apparatus 21 are connected to each other via the USB cable 31, and content recorded in the medium 23 is dubbed, in the HDD 52, title 1 including chapters 101 to 104 is recorded.

After that, it is assumed that, after the camcorder 22 shoots and records scenes 85 and 86 in the medium 23, the camcorder 22 and the recording apparatus 21 are connected to each other via the USB cable 31, and content recorded in the medium 23 is dubbed. At this time, the already shot scenes 81 to 84 are not deleted and are recorded in the medium 23.

In this case, the recording apparatus 21 can play back only two titles including chapters 121 and 122 without playing back title 1 including chapters 101 to 104 again, and can record the two titles in the HDD 52.

As shown in FIG. 4, the recording apparatus 21 can acquire a media ID of the medium 23 from the camcorder 22. The recording apparatus 21 can store, for example, in a predetermined storage area of the HDD 52, as a database, information in which the media ID and a capturing-completion scene ID are associated with each other.

FIG. 4 shows that, in dubbing processing, the recording apparatus 21 transmits, to the camcorder 22, a data acquiring request to acquire data of each scene to be captured in the present dubbing, and the camcorder 22 transmits the data of the scene as a stream to the recording apparatus 21. In addition, the recording apparatus 21 acquires a media ID of the medium 23, which is loaded, and generates information in which the media ID and a capturing-completion scene ID are associated with each other.

Here, a media ID is made up of, for example, a predetermined number (digits) of numerals and characters, and is a unique ID added to each medium such as the medium 23. A capturing-completion scene ID is a scene ID for specifying an already captured scene from a medium corresponding to the media ID. For example, in a case where scenes 81 to 84 have already been dubbed and captured in the recording apparatus 21, “ID4” that is a scene ID of scene 84 is used as a capturing-completion scene ID.

After the recording apparatus 21 dubs content from a certain medium, the recording apparatus 21 generates information in which a media ID of the medium and a capturing-completion scene ID are associated to each other, and stores the information in the database. As described above, in the database of the recording apparatus 21, information in which a media ID of each medium and each capturing-completion scene ID are associated with each other is cumulatively stored.

In other words, when the recording apparatus 21 dubs content in the medium 23 once, the recording apparatus 21 stores, in the database, information in which the media ID of the medium 23 and the capturing-completion scene ID are associated with each other. When the recording apparatus 21 dubs content of the medium 23, after the recording apparatus 21 searches the database on the basis of the media ID of the medium 23, and specifies to which scene the content was previously captured, the recording apparatus 21 can specify a scene to be captured.

As described above, by performing dubbing processing on the basis of information in which a media ID and a capturing-completion scene ID are associated with each other, for example, when the recording apparatus 21 dubs content from the medium 23, the recording apparatus 21 can perform acquisition from the continuation (for example, from scene 85) of the previously captured scene (for example, scene 84). In addition, the continuation scene of the previously captured scene can be easily specified by a scene ID. Thus, for example, in execution of dubbing, processing can be simplified.

However, in cases such as when particularly specified by the user, the recording apparatus 21 performs dubbing processing regardless of information in which a media ID and a capturing-completion scene ID are associated with other. For example, the recording apparatus 21 can capture the first scene (for example, scene 81) recorded in the medium 23.

FIG. 5 is a block diagram showing an example of a functional configuration of the control unit 51 in the recording apparatus 21. As shown in FIG. 5, the control unit 51 has a functional configuration at least including a media-type specifying portion 171, a capturing range setting portion 172, and a capturing executing portion 173. This configuration may be realized either by hardware or by software.

The media-type specifying portion 171 controls execution of processing that specifies a medium in a source device from which content to be dubbed is captured. For example, the media-type specifying portion 171 controls execution of processing that specifies the type of the medium 23 loaded into the camcorder 22 connected via the USB cable 31. Here, the media-type specifying portion 171 determines whether or not a medium in a source device from which content to be dubbed is captured is a medium in which content can be recorded in the format described with reference to FIG. 2. Specifying of the media type is performed on the basis of, for example, information representing a media manufacturer, the information being acquired together with the media ID.

The capturing range setting portion 172 controls processing that sets a range of scenes to be captured. In other words, the capturing range setting portion 172 sets a range from which scene to which scene of scenes recorded in a medium in a source device from which capturing is performed.

The capturing executing portion 173 controls execution of processing that generates a title by capturing a scene recorded in the medium in the source device from which capturing is performed, and records the title in the HDD 52. In addition, the capturing executing portion 173 controls execution of processing that generates or updates information in which a media ID and a capturing-completion scene ID are associated with other, the information being stored in the database described with reference to FIG. 4.

The capturing executing portion 173 can update the information in which the media ID and the capturing-completion scene ID are associated with other at a timing at which one title is recorded in the HDD 52. For example, in a case where scenes 81 to 87 are captured from the medium 23, when scenes 81 to 84 are captured and title 1 is recorded, information in which a media ID representing the medium 23 and the capturing-completion scene ID “ID4” are associated with each other is stored in the database. When scenes 85 and 86 are recorded and title 2 is recorded, the capturing-completion scene ID that is associated with the media ID representing the medium 23 is updated into “ID6”, and the information is stored in the database. In addition, when scene 87 is captured and title 3 is recorded, the capturing-completion scene ID that is associated with the media ID representing the medium 23 is updated into “ID7”, and the information is stored in the database.

Next, a data capturing process of the recording apparatus 21 will be described below with reference to the flowchart shown in FIG. 6. This process is executed, for example, when the camcorder 22 is connected to the recording apparatus 21 via the USB cable 31, and dubbing of content is commanded.

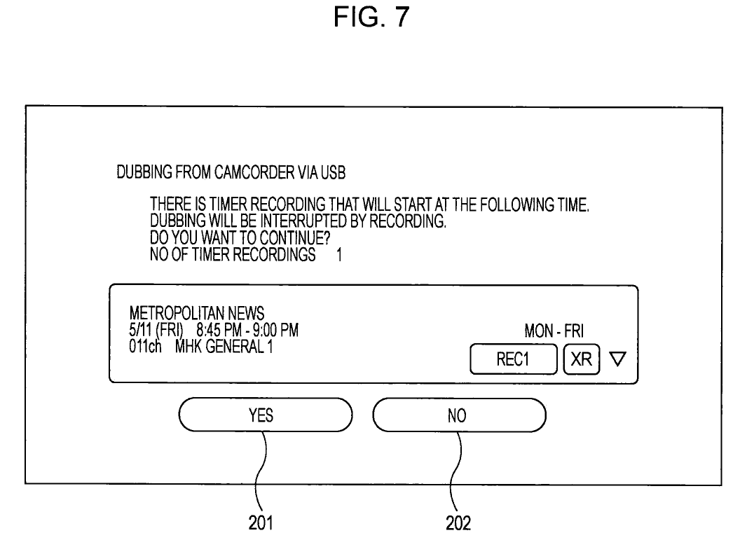

In step S11, the control unit 51 in the recording apparatus 21 executes a simultaneous operation confirming process. It is noted that the simultaneous operation confirming process is executed when the recording apparatus 21 is an apparatus that is unable to simultaneously execute different processes. In the simultaneous operation confirming process, for example, by checking information of timer recording preset in the recording apparatus 21, it is confirmed whether or not dubbing of content can be continued. For example, in a case where it is determined that timer recording preset in the recording apparatus 21 is to be executed, the screen shown in FIG. 7 is displayed on the display 24.

In the example shown in FIG. 7, the display 24 displays the message “THERE IS TIMER RECORDING THAT WILL START AT THE FOLLOWING TIME. DUBBING WILL BE INTERRUPTED BY RECORDING. DO YOU WANT TO CONTINUE?” Here, in a state in which timer recording of a program entitled “METROPOLITAN NEWS” that will be broadcast at 8:45 PM, it is determined that recording of “METROPOLITAN NEWS” is to be executed during execution of the capturing processing. In a case where the user operates a remote commander (not shown) to press a button 201, the capturing processing can continue. In a case where the user operates the remote commander to press a button 202, the capturing processing does not continue.

In step S12 in FIG. 6, as described above, it is determined whether or not the capturing processing can continue. If it is determined that the capturing processing continues, the process proceeds to step S13.

However, in a case where, in the recording apparatus 21, the dubbing processing can be executed simultaneously with execution of recording based on the preset timer recording, steps S11 and S12 do not need to be performed, and the process may be started from step S13.

In step S13, the control unit 51 checks a free capacity of the HDD 52. The checked free capacity of the HDD 52 is stored in an internal memory or the like in the control unit 51.

In step S14, the media-type specifying portion 171 in the control unit 51 checks a medium of a source device from which content to be dubbed is captured. Here, a media ID is acquired and a media type is specified. Specifying of the media type is performed on the basis of, for example, information representing a media manufacturer, and the information being acquired together with the media ID.

In step S15, the media-type specifying portion 171 determines whether or not the medium in the source device from which capturing is performed is a predetermined type of medium. Here, it is determined whether or not the medium in the source device is a medium in which content can be recorded in the format described with reference to FIG. 2. In a case where the medium in the source medium is a medium in which content can be recorded in the format described with reference to FIG. 2, that is, in a case where the medium in the source device is specified as a medium in which scenes are recorded with scene IDs added thereto, in step S15, it is determined that the medium in the source device is a predetermined type of medium. Then, the process proceeds to step S16.

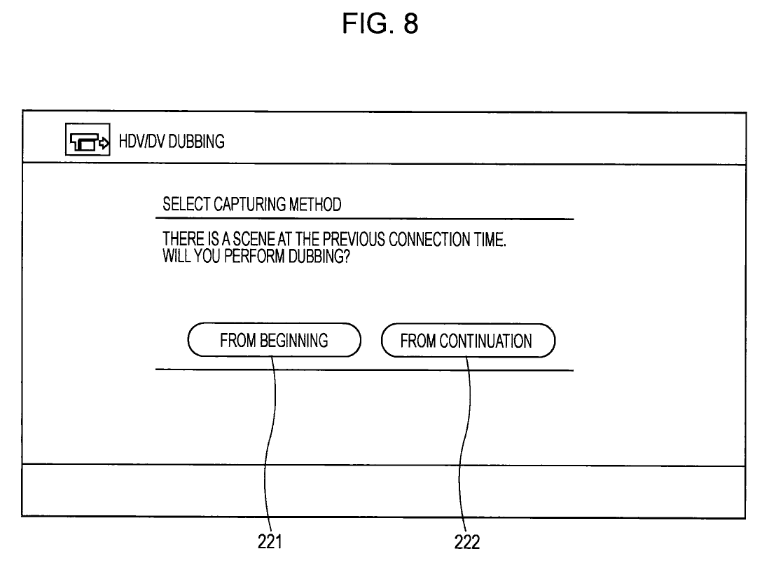

In step S16, the capturing range setting portion 172 in the control unit 51 allows the user to select a capturing method. In step S17, the capturing range setting portion 172 determines the selected capturing method. Here, the capturing method is one that performs capturing from the continuation of the previously captured scene, or one that performs capturing from the first scene recorded in the medium. In connection with step S16, the display 24 displays, for example, the screen shown in FIG. 8, and user's selection is input.

In the example shown in FIG. 8, buttons 221 and 222 are displayed. In a case where the user operates the remote commander to press the button 221, which represents capturing from the first scene recorded in the medium, the process proceeds to step S20 in FIG. 6. In a case where the user operates the remote commander to press the button 222, which represents capturing from the continuation from the previously captured scene, the process proceeds to step S18.

On the basis of the media ID acquired in step S14, the database described with reference to FIG. 4 is searched for. Only when information corresponding to the media ID exists does the display 24 display the screen shown in FIG. 8, and the user is allowed to select between the buttons 221 and 222. In a case where information corresponding to the media ID does not exist, steps S16 and S17 are skipped over, and the process may proceed to step S20.

In addition, if, in step S15, it is determined that the media in the source device is not a predetermined type of medium, steps S16 and S17 are skipped over, and the process proceeds to step S20.

In a case where the process proceeds to step S18, in step S18, the capturing range setting portion 172 specifies a capturing-start scene by specifying a capturing-completion scene ID associated with the media ID from information obtained by searching the database described with reference to FIG. 4 on the basis of the media ID acquired in step S14.

For example, in a case where the source medium is the medium 23, and a capturing-completion scene ID that is associated with a media ID representing the medium 23 is “ID4”, in step S18, the capturing range setting portion 172 specifies scene 85 whose scene ID is “ID5” as a capturing-start scene”.

In step S19, the capturing range setting portion 172 specifies a capturing-end scene. Here, it is determined how many scenes recorded in the medium can be captured on the basis of the free capacity of the HDD 52 obtained in step S13. If it is determined that scenes from the capturing-start scene specified in step S18 through the last scene recorded in the medium can be captured, the last scene recorded in the medium is used as a capturing-end scene. Alternatively, if it is determined that scenes from the capturing-start scene specified in step S18 through the last scene recorded in the medium are unable to be captured, the number of scenes that corresponds to the amount of data determined according to the free capacity of the HDD 52 is specified and the last scene among the scenes is used as a capturing-end scene.

In a case where the process proceeds to step S20, in step S20, the capturing range setting portion 172 specifies the first scene recorded in the medium as a capturing-start scene.

In step S21, the capturing range setting portion 172 specifies a capturing-end scene. Here, on the basis of the free capacity of the HDD 52 obtained in step S13, it is determined whether all the scenes recorded in the medium can be captured. If it is determined that scenes from the capturing-start scene (the first scene) specified in step S20 to the last scene recorded in the medium can be captured, the last scene recorded in the medium is used as a capturing-end scene. Alternatively, if it is determined that scenes from the capturing-start scene specified in step S20 to the last scene recorded in the medium are unable to be captured, the number of scenes that corresponds to the amount of data according to the free capacity of the HDD 52 is specified and the last scene is used as a capturing-end scene.

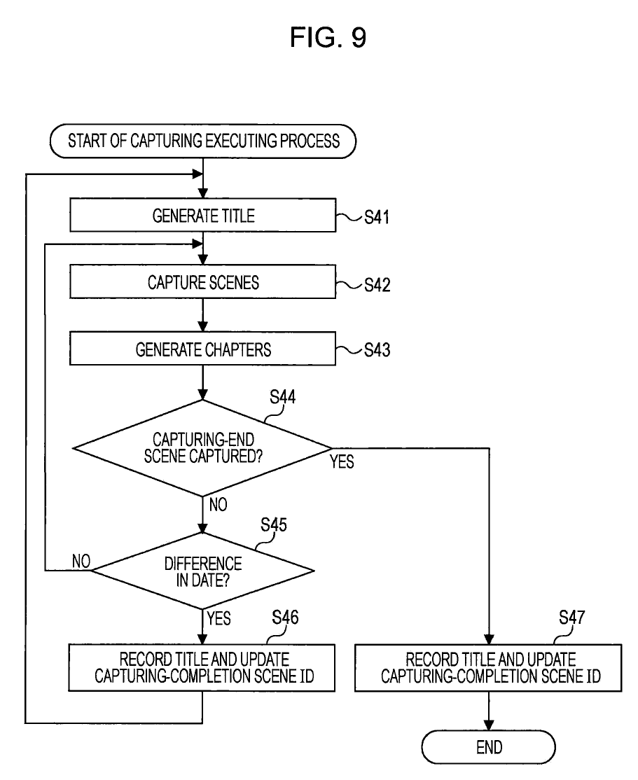

After step S19 or step S21, the process proceeds to step S23. In step S23, a capturing executing process, which is described later with reference to FIG. 9, is executed.

Next, details of the capturing executing process in step S23 in FIG. 6 will be described below with reference to the flowchart shown in FIG. 9. In step S41, the capturing executing portion 173 in the control unit 51 generates a title. As described above, the title is generated so as to correspond to a shooting date of a scene.

In step S42, the capturing executing portion 173 captures scenes. An initially captured scene is the capturing-start scene specified in step S18 or S20 in FIG. 6.

In step S43, the capturing executing portion 173 generates chapters corresponding to the scene captured in step S42.

In step S44, the capturing executing portion 173 determines whether or not the capturing-end scene specified in step S19 or S21 has been captured. If the capturing executing portion 173 has determined that the capturing-end scene has not been captured, the process proceeds to step S45.

In step S45, the capturing executing portion 173 determines whether or not there is a difference between the date of the scene captured in step S42 and the date (shooting date) of the next scene to be captured. If, in step S45, the capturing executing portion 173 has determined that there is no difference in date, the process returns to step S42, and the next scene is captured.

Processing in step S42 to S45 is repeatedly executed until it is determined in step S44 that the capturing-end scene has been captured or it is determined in step S45 that there is a difference in date.

If, in step S45, it is determined that there is a difference in date, the process proceeds to step S46.

In step S46, the capturing executing portion 173 records the title in the HDD 52, and updates a capturing-completion scene ID associated with the media ID in the database described with reference to FIG. 4.

After step S46, the process returns to step S41. In step S41, a title corresponding to the shooting date of the next scene is generated and processing in steps S42 to S45 is executed.

Alternatively, if, in step S44, it is determined that the capturing-end scene has been captured, the process proceeds to step S47. In step S47, the capturing executing portion 173 records the title in the HDD 52, and updates a capturing-completion scene ID associated with the media ID in the database described with reference to FIG. 4. The process finishes.

In a case where, in step S16 in FIG. 6, the user presses the button 221 (FIG. 8) representing capturing from the first scene recorded on the medium despite that dubbing of content recorded in the medium was previously executed, information updating is not performed in steps S46 and S47 unless scenes are captured exceeding an already stored capturing-completion scene ID.

In a case where scenes 81 to 87 have already been captured by previously performed dubbing processing, when scenes 81 to 84 are captured and title 1 is recorded, information in which a media ID representing the medium 23 and the capturing-completion scene ID “ID4” are associated with each other is stored in the database of the recording apparatus 21. In a case where, from this state, dubbing is performed from the medium 23, the user selects, as the capturing method (dubbing method), capturing from the first scene recorded on the medium, and three scenes, scenes 81 to 83, are captured again and the process finishes, information in which the media ID representing the medium 23 and the capturing-completion scene ID “ID4” are associated with each other is not updated.

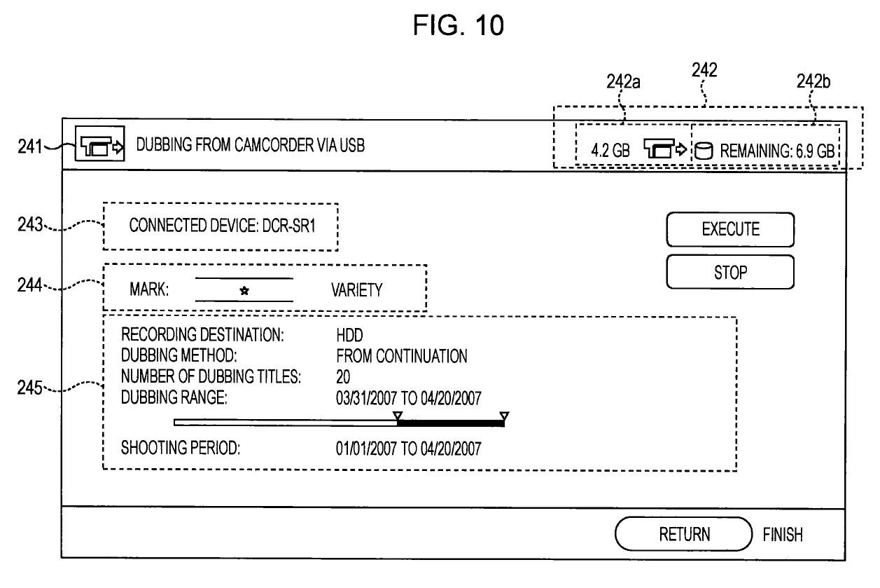

Before the process described with reference to FIG. 9, after, for example, step S19 or step 21 in FIG. 6, the recording apparatus 21 causes the display 24 to display, for example, the screen shown in FIG. 10.

In the example shown in FIG. 10, an icon 241 in a top left portion represents execution of dubbing from the camcorder 22 connected via the USB cable 31.

In addition, a region 242 on the screen shown in FIG. 10 includes a small region 242a that indicates the amount of data of scenes from a capturing-start scene to a capturing-end scene to be captured, and a camcorder, an icon indicating the HDD 52 as a capturing destination, and a small region 242b representing the free (remaining) capacity (“REMAINING”) of the HDD 52. In this example, the amount of data to be captured is indicated as 4.2 GB, and the free capacity is indicated as 6.9 GB. The free capacity of the HDD 52 may be periodically checked and updated.

A region 243 indicates a model name of the camcorder 21 connected via the USB cable 31. The region 243 may also indicate a manufacturer of the camcorder 22.

A region 244 indicates a mark representing a genre of the scenes to be captured. In this example, the region 244 indicates a star mark and “VARIETY”. In other words, the scenes to be captured belong to the genre “VARIETY”. For example, when a title recorded in the HDD 52 is displayed, the star mark is indicated, if necessary. Regarding genres, not only “VARIETY”, but also a plurality of genres such as “SPORTS” and “DRAMA” can be set. Also, marks corresponding to the genres can be set by the user, if necessary.

A region 245 indicates detailed information concerning dubbing. In this example of the region 245, “RECORDING DESTINATION: HDD” is indicated in the first row in the region 245. This indicates that a recording medium serving as a recording destination (capturing destination) is the HDD 52.

In the second row in the region 245, “DUBBING METHOD: FROM CONTINUATION” is indicated. This indicates that the capturing (dubbing method) selected in step S16 in FIG. 6 represents capturing from “continuation”, that is, capturing from the continuation of a previously captured scene. In a case where the capturing method (dubbing method) selected in step S16 in FIG. 6 represents capturing from the first scene recorded in the medium, in the second row in the region 245, “DUBBING METHOD: FROM BEGINNING” is indicated.

In the third row in the region 245, “NUMBER OF DUBBING TITLES: 20” is indicated. This indicates that the number of titles to be generated by executing the process described with reference to FIG. 9 is 20. In other words, this indicates that shooting dates of scenes to be captured are 20 different dates.

In the fourth row in the region 245, “DUBBING RANGE: 03/31/2007 TO 04/20/2007” is indicated. This indicates that the shooting date of the capturing-start scene is Mar. 31, 2007 (03/31/2007) and the shooting date of the capturing-end scene is Apr. 20, 2007 (04/20/2007).

In the fifth row in the region 245, a bar chart is indicated.

In the sixth row in the region 245, “SHOOTING PERIOD: 01/01/2007 TO 04/20/2007” is indicated. This indicates that the shooting date of the first scene recorded on the medium in the camcorder is Jan. 1, 2007 (01/01/2007), and that the last scene recorded in the medium of the camcorder is Apr. 20, 2007 (04/20/2007).

Regarding the bar chart in the fifth row in the region 245, the most left position of the bar corresponds to the first shooting date (01/01/07) recorded in the medium of the camcorder, and the most right position of the bar corresponds to the last scene (04/20/2007) recorded in the medium of the camcorder. In addition, two inverted triangle marks are indicated on the bar. The position of the left inverted triangle mark in FIG. 10 corresponds to the shooting date (03/31/2007) of the capturing-start scene. The position of the right inverted triangle mark in FIG. 10 corresponds to the shooting date (04/20/2007) of the capturing-end scene. In other words, the amount of data of scenes recorded in the medium of the camcorder is treated as 100% and indicated as the bar. The black portion on the bar indicates a range of scenes to be captured.

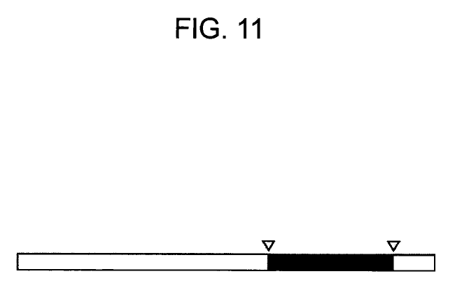

For example, in a case where the free capacity of the HDD 52 is insufficient, and scenes from the capturing-start scene to the last scene recorded in the medium are unable to be captured, the bar chart in the fifth row in the region 245 is indicated as shown in FIG. 11.

In the example shown in FIG. 11, regarding the inverted triangle marks on the bar, the position of the right inverted triangle is more left than that shown in FIG. 10. This case indicates that the shooting date of the capturing-end scene does not coincide with the shooting date of the last scene recorded in the medium.

By displaying this screen, information of dubbing processing to be executed can be reported in a user-friendly manner.

By pressing an “EXECUTE” button indicated on the right side of FIG. 10, the process described with reference to FIG. 9 is executed. By pressing a “STOP” button, the process described with reference to FIG. 9 is not executed.

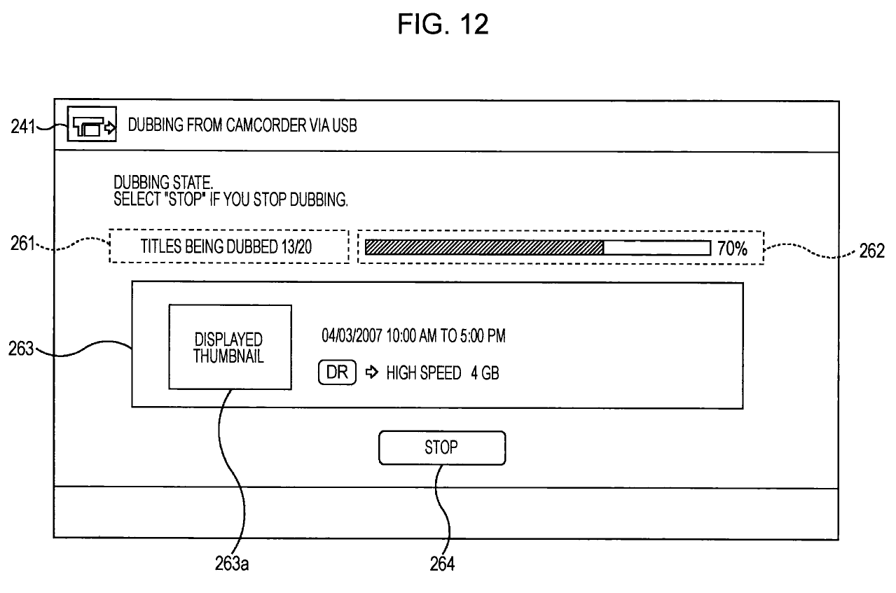

During the process described with reference to FIG. 9, the recording apparatus 21 causes the display 24 to display, for example, the screen shown in FIG. 12.

In a top left portion of the screen shown in FIG. 12, also the icon 241 represents execution of dubbing from the camcorder 22 connected via the USB cable 31 is indicated.

In a region 261 in FIG. 12, “TITLES BEING DUBBED 13/20” is indicated. This indicates that the number of titles to be generated by executing the process described with reference to FIG. 9 is 20, and that the 13th title is currently being generated.

In a region 262, a bar chart is indicated. Here, the amount of data of scenes from the capturing-start scene to the capturing-end scene is treated as 100% and is indicated as a bar. A portion of the bar that corresponds to the amount of data of already captured scenes is indicated as a hatched portion. This example indicates that 70% of the amount of data of scenes to be captured have already been captured.

A region 263 indicates information concerning a scene being currently captured. A box 263a in the region 263 displays a thumbnail of a scene being currently captured. The thumbnail is, for example, an image obtained by playing back the first I picture in data of the scene.

On the right side of the box 263a, “04/03/2007 10:00 AM TO 5:00 PM” is indicated. This indicates that the scene being currently captured is made up of temporally consecutive moving images in which shooting was started on Apr. 3, 2007 (04/03/2007), 10:00 AM, and the shooting was ended on 5:00 PM.

By displaying this screen, information of the progress of dubbing processing being currently executed can be reported in a user-friendly manner.

By pressing the button 264 shown in FIG. 12, the process described with reference to FIG. 9 is temporarily stopped.

The foregoing describes a case in which the recording apparatus 21 is used as an HDD recorder. However, the recording apparatus 21 may be formed by, for example, a personal computer. In addition, the recording medium in the capturing destination is not limited to the HDD. A digital versatile disc or the like may be used.

In addition, the source device from which capturing is performed is not limited to a camcorder. The source device may be a device into which a medium containing content can loaded.

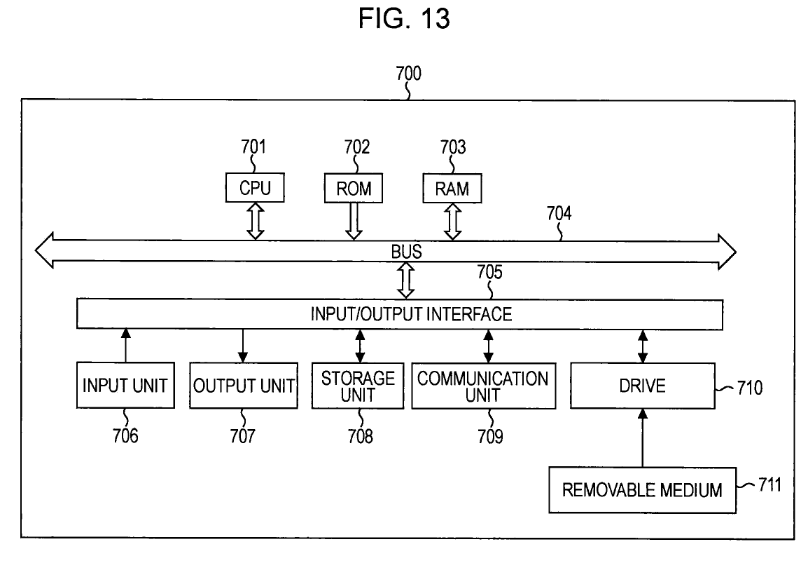

The above-described consecutive processing can be executed either by hardware or by software. In the case of using software to execute the consecutive processing, programs constituting the software are installed from a network or recording medium to a computer built into dedicated hardware or, for example, the multi-purpose personal computer 700 shown in FIG. 13 in which various functions are executed by installing various programs.

In FIG. 13, a central processing unit (CPU) 701 executes various types of processing in accordance with programs stored in a read-only memory (ROM) 702, or programs loaded from a storage unit 708 into a random access memory (RAM) 703. The RAM 703 stores data necessary for the CPU 701 to execute various types of processing, if necessary.

The CPU 701, the ROM 702, and the RAM 703 are connected to one another via a bus 704. An input/output interface 705 is connected to the bus 704.

An input unit 706 including a keyboard and a mouse, a display formed by a cathode ray tube (CRT) or a liquid crystal display (LCD), an output unit 707 including a speaker, a storage unit 708 including a hard disk, a communication unit 709 formed by a network interface card such as a modem or local area network (LAN) card are connected to the input/output interface 705. The communication unit performs communicating processing via networks including the Internet.

A drive 710 is connected to the input/output interface 705, if necessary. A removable medium 711, such as a magnetic disk, an optical disc, a magneto-optical disc, or a semiconductor memory, is loaded into the drive 710, if necessary, and a computer program read from the removable medium 711 is installed in the storage unit 708, if necessary.

In the case of using software to execute the consecutive processing, programs constituting the software are installed from a network such as the Internet, or a recording medium such as the removable medium 711.

Types of the recording medium include not only the removable medium 711, which is distributed separately from the apparatus shown in FIG. 13 in order to deliver a program to a user, which contains the program, such as a magnetic disk (including a floppy disk), an optical disc (including a compact-disc read-only memory), a DVD, or a magneto-optical disc (MiniDisc), but also the ROM 702, which contains a program, which is delivered to a user in a built-in form, and a hard disk in the storage unit 708.

Steps that execute the consecutive processing in this specification include processing steps executed in a time-series manner in given order, and include processing steps that are executed in parallel or individually if they are not necessarily executed in a time-series manner.

It should be understood by those skilled in the art that various modifications, combinations, sub-combinations and alterations may occur depending on design requirements and other factors insofar as they are within the scope of the appended claims or the equivalents thereof.

What is claimed is:

1. A recording apparatus for dubbing moving image content recorded in a recording medium loaded into a different apparatus connected to the recording apparatus, the recording apparatus comprising:
a database configured to store information in which the recording medium and identifiers are associated with each other, the identifiers specifying already dubbed scenes among scenes that are unit data items forming the content recorded in the recording medium;
media-type determining means for determining whether or not the recording medium in the different apparatus is a predetermined type of recording medium in which the content can be recorded in a form in which a unique identifier is added to each of the scenes forming the content; and
dubbing range setting means for setting a dubbing range by using, as a new scene to be dubbed, a scene different from the already dubbed scenes on the basis of the information stored in the database when the media-type determining means determines that the recording medium in the different apparatus is the predetermined type of recording medium.

2. The recording apparatus according to claim 1,
wherein, on the basis of the information stored in the database, the dubbing range setting means specifies the first scene to be newly dubbed among temporally consecutive scenes forming the content, and
wherein, on the basis of a free capacity of a recording medium in the recording apparatus, which contains the dubbed content, the dubbing range setting means sets the dubbing range by specifying the last scene to be newly dubbed among the temporally consecutive scenes forming the content.

3. The recording apparatus according to claim 2,
wherein, when the media-type determining means determines that the recoding medium in the different apparatus is not the predetermined type of recording medium, the dubbing range setting means specifies, as the first scene to be newly dubbed, the temporally oldest scene recorded in the recording medium in the different apparatus.

4. The recording apparatus according to claim 1, further comprising recording executing means for generating titles that are data items of recording units on the basis of shooting dates of the scenes, and recording the titles in the recording medium in the recording apparatus.

5. A recording method for a recording apparatus that dubs moving image content recorded in a recording medium loaded into a different apparatus connected to the recording apparatus, the recording method comprising the steps of:
determining whether or not the recording medium in the different apparatus is the predetermined type of recording medium in which the content can be recorded in a form in which a unique identifier is added to each of scenes forming the content; and
when it is determined that the recording medium in the different apparatus is the predetermined type of recording medium, on the basis of information in which the recording medium and identifiers are associated with each other, the identifiers specifying already dubbed scenes among scenes that are unit data items forming the content recorded in the recording medium, the information being stored in a database, setting a dubbing range by using, as a new scene to be dubbed, a scene different from the already dubbed scenes.

6. A program for causing a computer to function as a recording apparatus that dubs moving image content recorded in a recording medium loaded into a different apparatus connected to the recording apparatus, the recording apparatus comprising:
a database configured to store information in which the recording medium and identifiers are associated with each other, the identifiers specifying already dubbed scenes among scenes that are unit data items forming the content recorded in the recording medium;
media-type determining means for determining whether or not the recording medium in the different apparatus is a predetermined type of recording medium in which the content can be recorded in a form in which a unique identifier is added to each of the scenes forming the content; and
dubbing range setting means for setting a dubbing range by using, as a new scene to be dubbed, a scene different from the already dubbed scenes on the basis of the information stored in the database when the media-type determining means determines that the recording medium in the different apparatus is the predetermined type of recording medium.

7. A recording medium to be loaded into a different apparatus connected to a recording apparatus comprising:
a database configured to store information in which the recording medium in the different apparatus and identifiers are associated with each other, the identifiers specifying already dubbed scenes among scenes that are unit data items forming the content recorded in the recording medium;
media-type determining means for determining whether or not the recording medium in the different apparatus is a predetermined type of recording medium in which the content can be recorded in a form in which a unique identifier is added to each of the scenes forming the content; and
dubbing range setting means for setting a dubbing range by using, as a new scene to be dubbed, a scene different from the already dubbed scenes on the basis of the information stored in the database when the media-type determining means determines that the recording medium in the different apparatus is the predetermined type of recording medium,
wherein the content is recorded in a form in which a unique identifier is added to each of the scenes forming the content.

8. A recording apparatus for dubbing data recorded in a recording medium, the recording apparatus comprising:
a database configured to store information in which the recording medium and identifiers are associated with each other, the identifiers specifying already dubbed unit data items among unit data items recorded in the recording medium;
media-type determining means for determining whether or not the recording medium is a predetermined type of recording medium in which the data items can be recorded in a form in which a unique identifier is added to each of the unit data items; and
dubbing range setting means for setting a dubbing range by using, as a new unit data item to be dubbed, a unit data item different from the already dubbed unit data items on the basis of the information stored in the database when the media-type determining means determines that the recording medium is the predetermined type of recording medium.

9. A recording method for a recording apparatus that dubs data items recorded in a recording medium, the recording method comprising the steps of:
determining whether or not the recording medium is a Predetermined type of recording medium in which the data items can be recorded in a form in which a unique identifier is added to each of unit data items; and
when it is determined that the recording medium is the predetermined type of recording medium, on the basis of information in which the recording medium and identifiers are associated with each other, the identifiers specifying already dubbed unit data items among the unit data items recorded in the recording medium, the information being stored in a database, setting a dubbing range by using, as a new unit data item to be dubbed, a unit data item different from the already dubbed unit data items.

10. A recording apparatus for dubbing moving image content recorded in a recording medium loaded into a different apparatus connected to the recording apparatus, the recording apparatus comprising:
a database configured to store information in which the recording medium and identifiers are associated with each other, the identifiers specifying already dubbed scenes among scenes that are unit data items forming the content recorded in the recording medium;
a media-type determining unit configured to determine whether or not the recording medium in the different apparatus is a predetermined type of recording medium in which the content can be recorded in a form in which a unique identifier is added to each of the scenes forming the content; and
a dubbing range setting unit configured to set a dubbing range by using, as a new scene to be dubbed, a scene different from the already dubbed scenes on the basis of the information stored in the database when the media-type determining unit determines that the recording medium in the different apparatus is the predetermined type of recording medium.

11. A recording apparatus for dubbing data recorded in a recording medium, the recording apparatus comprising:
a database configured to store information in which the recording medium and identifiers are associated with each other, the identifiers specifying already dubbed unit data items among unit data items recorded in the recording medium;
a media-type determining unit configured to determine whether or not the recording medium is a predetermined type of recording medium in which the data items can be recorded in a form in which a unique identifier is added to each of the unit data items; and
a dubbing range setting configured to set a dubbing range by using, as a new unit data item to be dubbed, a unit data item different from the already dubbed unit data items on the basis of the information stored in the database when the media-type determining unit determines that the recording medium is the predetermined type of recording medium.
